(19) United States
(12) Patent Application Publication
(10) Pub. No.: US 2004/0198314 A1
(43) Pub. Date: Oct. 7, 2004

(54) Personnel emergency assistance device

(76) Inventor: Paul S. Pardue, Corinth, MS (US)

Correspondence Address: PAUL S. PARDUE, 1616 Wenasoga Rd., CORINTH, MS, 38834, US

(21) Appl. No.: 10/407,958

(22) Filed: Apr. 7, 2003

(51) Int. Cl. H04Q 7/20; H04M 11/00

(52) U.S. Cl. 455/404.1; 455/403

(57) ABSTRACT

It is necessary in our times to provide affordable, dependable and quick access to emergency personnel for those who are disabled or have life threatening situations. This invention bypasses the complex methods previously used in personal assistance devices by eliminating the need for a secondary party such as a monitoring system external to the E911 system already in existence. The E911 system established is built to handle and identify telephone numbers dialed into its system and is able to determine when an emergency exists. This invention works directly with the E911 system and works in a most simple form that should satisfy any person requiring a means of notifying E911 of an emergency from a remote location within but limited to ones home or dwelling place. Thus a reduction is cost and a decrease in response time is achieved.

This invention is for enabling a person who is unable to reach or dial a telephone in the case of a life or death situation, to alert emergency personnel without having to move from his or her physical location. The invention works directly with the E911 system. If a telephone call is received by any 911 office and the person calling 911 can not verbally respond to questions from the office personnel and the telephone line is offhook (dead line) and remains in an off-hook mode then the operator at 91 1 does two things. The 911 office is aware of the number called from and he or she either checks their data base (most offices are equipped with such) for special information regarding the calling number and if it is noted that the person has a device of this sort or that they have life threatening ailments that a dispatch is immediately sent to that residence to determine the problem.

This invention is not an automated device but a personally activated device which can only be activated by a human at the calling end. This differs from automated home security units. The home security units available on the open market are much more apt to false alarm due to the number of sensors involved in the system This invention will not false alarm any more than a cordless telephone or cellular telephone since it is a human activated device. The invention also does not depend on a monitoring service which would simply follow the same procedure as the 911 office. Implementing this invention nationwide would reduce the cost and make affordable a personal emergency device to the consumer which could work much more efficiently and reduce the number of false alarms being sent to 911. This is a new invention but also improves a system already in existence.

Another use can be that of a panic button, unseen by an intruder, to be used at banks, gas stops and many other businesses as a silent alarm.

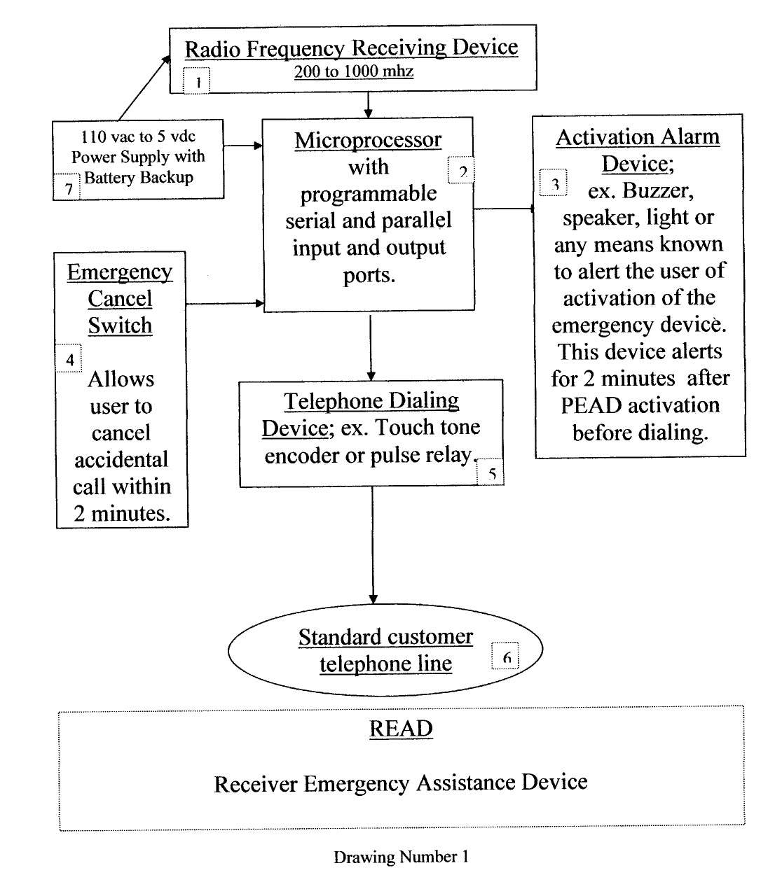

The system involves the use of a transmitter of low power (1 milliwatt) and should be in the frequency range of 200 to 1000 mhz (Drawing 2, FIG. 1. The transmitter device is powered by 2 small wafer type batteries or batteries that produce a minimum of 3 volts . Drawing 2, FIG. 2. The transmitter must be capable of OOK, FM or FSK modulation, either of which is effective in this invention. This will allow a range of up to 500 feet when based on a receiver of −100 dbm sensitivity. The range decreases with the number and type of surrounding objects and the antenna (Drawing 2, FIG. 5) incorporated. The range will always exceed 100 feet which is capable of covering most any indoor dwellings. With additional “type acceptation” from the Federal Communication Commission, increased power can be used to increase the effective range of the device.

The transmitter is en-housed in a wristband, necklace pendant, watch or other personal item which is attractive and does not draw public attention. The transmitter device has a passive switch (Drawing 2, FIG. 3) incorporated which upon depressing actives the transmitter. The passive switch has a cover over it which must slide out of the way to give access to the switch. This is similar to a key hole cover. The cover prevents the switch from accidentally being depressed but is easily moved for those in an emergency situation. Once the cover is moved then the user presses the push button passive switch. The activation switch if not included with an access cover will always have some means of protecting it from accidental depression.

The transmitter unit incorporates a microprocessor (Drawing 2, FIG. 1) and micro-transmitter which is capable of being battery operated and can only be turned on by the depression of the activation switch. Once the button is depressed and the microprocessor is turned on then two 8 bit computer bytes are relayed by wire to the micro-transmitter unit. The transmitter unit then transmits these two 8 bit bytes at radio frequency. These 8 bit bytes are used to eliminate false triggering of the device and are unique bytes for each transmitter unit.

The receiver (Drawing 1, FIG. 1) is powered by (Drawing 1, FIG. 7) household current and is backed up by a battery supply in case of power failure during a power outage. The receiver exists of a micro-receiver with a receive sensitivity of −100 dbm or less which is capable of receiving the frequency and modulation method generated by the transmitter unit. A microprocessor is also included in the receiving unit. Once the two 8 bit data bytes are seen at the receiver they are passed to the microprocessor (Drawing 1, FIG. 2) which decodes the 8 bit data bytes as an identification that the transmitter in the system is trying to communicate with the receiver system. The receiver housing is suitable to protect the user from electrical shock and is capable of protecting the electronics inside.

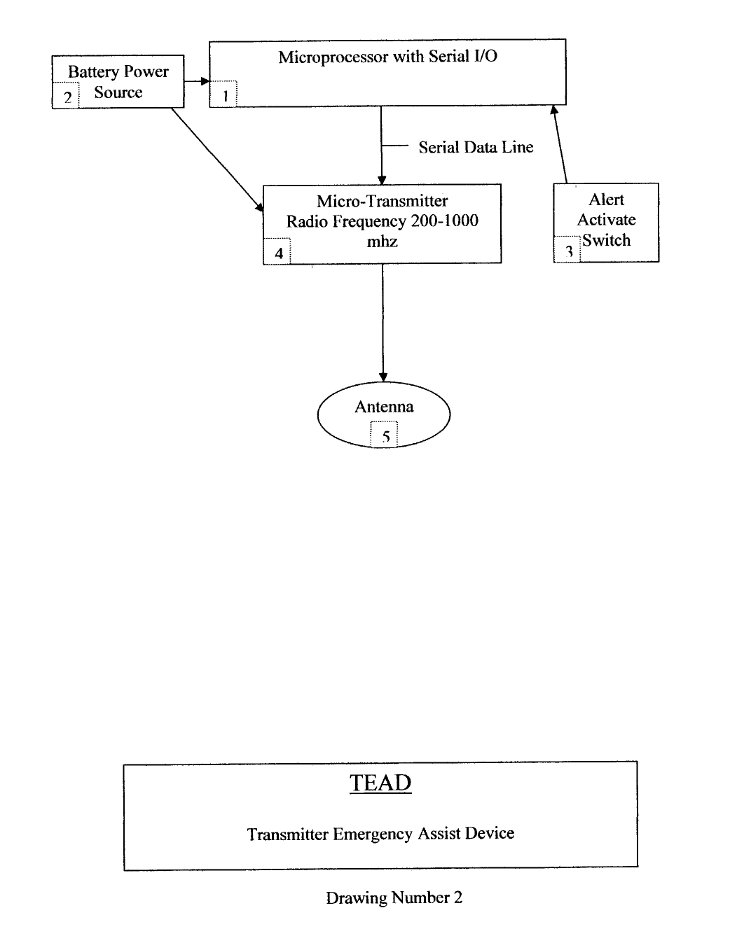

The microprocessor then goes into action by setting an audible alarm (Drawing 1, FIG. 3), capable of being heard by the operator of the device, for a period of 2 minutes. During this two minutes the operator is given the opportunity to cancel the operation via an emergency cancellation switch (Drawing 1, FIG. 4) of the device and reset it for further use. This has the purpose of eliminating false alarms. After the 2 minutes have expired the microprocessor then utilizing the telephone line (Drawing 1, FIG. 6), dials the number (Drawing 1, FIG. 5) 911 through a relay, switching transistors or similar switching arrangement such as opto-couplers or touch tone. Pulse type dialing is preferred so that the invention can be used to cover all parts of the country which may not yet have touch tone provisions. Once the number is dialed the line remains in an off hook (dead line) condition until reset by emergency personnel or an end user upon completion of the visit by emergency personnel.

Once the off-hook (dead line) condition is recognized by the 911 office the number dialed from is recognized by their information screen and assistance must be dispatched. No need is required to transmit information data to 911 as the dead line is the only information needed.

1. What I claim as my invention is a wireless device, transmitter and receiver, which is connected to an ordinary telephone line. The transmitter, which is worn by a human, will cause an emergency phone number (911) to be dialed by the receiver due to the simple depression of a button on the transmitter. The telephone line will then remain in an off hook condition indicating to (911) personnel of a pending emergency.
Other uses for this invention are numerous. Personal panic buttons for bank attendants, convenience store operators and other stores which are robbery prone are obviously priority uses for this invention.
